(19) United States
(12) Patent Application Publication
(10) Pub. No.: US 2010/0317354 A1
(43) Pub. Date: Dec. 16, 2010

(54) FREQUENCY PLANNING FOR A CELLULAR COMMUNICATION SYSTEM

(75) Inventor: Tim Kirvar, Wiltshire (GB)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 12/745,649

(22) PCT Filed: Nov. 14, 2008
(86) PCT No.: PCT/US08/83553

§ 371 Date: Jun. 1, 2010

(30) Foreign Application Priority Data
Dec. 3, 2007 (GB) 0723614.4

(51) Int. Cl. H04W 16/14

(52) U.S. Cl. 455/447

(57) ABSTRACT

An apparatus for frequency planning for a cellular communication system comprises a receiver (201) receiving measurement reports from remote stations. An interference processor (203) determines, for each of a plurality of cells, a neighbour cell interference relationship between at least a first and a second neighbour cell for the cell in response to measurement reports from remote stations served by the cell. The neighbour cell interference relationship is indicative of interference from the first to the second neighbour cell. The first and second cells are both neighbours of an intermediate cell but are not (necessarily) neighbours of each other. A frequency planner (205) determines a frequency plan in response to the neighbour cell interference relationships. The invention may allow the interference impact on neighbours of neighbour cells to be estimated and taken into account in the frequency plan thereby leading to improved frequency plans and performance of the cellular communication system.

### FIELD OF THE INVENTION

The invention relates to frequency planning for a cellular communication system and in particular, but not exclusively, to frequency planning for a Global System for Mobile communication (GSM).

### BACKGROUND OF THE INVENTION

Within Cellular networks, such as the Global System for Mobile communication (GSM) there is a fundamental need to reduce Radio Frequency (RF) interference in the system. Interference is caused when a radio receives a signal from a source that prevents or degrades decoding of the signal intended for that receiver. This interfering source is either transmitting on the same frequency or on a close frequency to the intended signal. In cellular networks there is multiple radio transmitters positioned to provide a radio signal, or coverage within an intended geographical area, known as a cell. Since there are fewer frequencies than transmitters, to reduce interference, each transmitter is allocated a frequency that would not be received in an area where another transmitter on the same frequency is also received. Thus, frequency reuse is employed.

The term given to multiple signals from separate transmitters being received at the same geographical location is termed as coverage overlap. Coverage overlap occurring when transmitters are on the same or close frequencies results in interference.

Network operators use propagation tools to predict how strong radio signals from separate transmitter are received in different locations. Using this information, frequency planning can be performed such that individual frequencies can be allocated to cells in a suitable reuse pattern.

In addition to propagation tools, measurement reports generated by radios using the network can be utilised. Measurement reports are generated by the mobile equipment to maintain the radio link and to aid handovers. Measurement reports typically contain signal strength measurements from the serving cell and neighbouring cells.

The use of measurements allows the propagation based determinations to be replaced or enhanced by the use of real data gathered in a fully operational and active system. This can substantially enhance the propagation predictions and can lead to improved frequency plans.

In such systems, the measurement report's indication of relative signal levels from pilot signals from the serving cell and neighbour cells can be used to determine coverage overlaps and interference relationships between a cell and its neighbouring cells. For example, a high value of the interference relationship can indicate that a neighbour cell would cause significant interference to the serving cell if this neighbour cell is allocated the same frequency as the serving cell.

Specifically, the method can be used to create a relationship between pairs of adjacent cells in numerical terms which is then used by suitable frequency planning tools. The numerical relationships are typically also referred to as penalty values that reflect the negative impact or the penalty to the network when the two associated cells are allocated the same frequency. The list of penalties between cells is often referred to as a penalty matrix. The frequency planning tool allocates frequencies to cells such that a combined penalty measure is minimized.

However, although adequate performance can be achieved in many scenarios, the described approach also has a number of associated disadvantages. For example, the generated penalty values from measurement reports only reflect interference relationships between adjacent cells and therefore can only reflect the penalty of allocating the same frequency to adjacent cells. However, in order to optimize a frequency plan the penalty matrix preferably needs to capture the negative impact of every co-channel frequency allocation in the network. Thus, often the described approach may result in suboptimal frequency plans and thus reduced performance of the cellular communication system.

Hence, an improved system for frequency planning would be advantageous and in particular a system allowing increased flexibility, facilitated operation, improved and/or facilitated frequency planning and/or improved performance of the cellular communication system would be advantageous.

### SUMMARY OF THE INVENTION

Accordingly, the Invention seeks to preferably mitigate, alleviate or eliminate one or more of the above mentioned disadvantages singly or in any combination.

According to an aspect of the invention there is provided an apparatus for frequency planning for a cellular communication system, the apparatus comprising: means for receiving measurement reports from a plurality of remote stations; interference determining means for, for each of a plurality of cells, determining a neighbour cell interference relationship between at least a first neighbour cell and a second neighbour cell of the cell in response to measurement reports from remote stations served by the cell, the neighbour cell interference relationship being indicative of an interference from the first neighbour cell to the second neighbour cell; and means for determining a frequency plan in response to the neighbour cell interference relationships.

The invention may allow improved and/or facilitated frequency planning. In particular, a frequency plan may be generated taking into account improved and or additional interference relationships thereby allowing an improved frequency plan to be generated. In particular, the invention may allow a frequency plan to take into account interference relationships between cells which are not adjacent or neighbours of each other but are both neighbours of the same cell. In many scenarios, measurement reports may be used to determine interference relationships between cells in a second layer of neighbour cells (i.e. between a cell and the neighbours of neighbour cells rather than just between the cell its neighbours).

An improved performance of the cellular communication system as a whole may be achieved from an improved frequency plan. In particular, handover performance between cells may be improved resulting e.g. in reduced call drops.

The plurality of cells may specifically comprise all cells within a given geographical area for which the frequency plan is generated.

The first and second cell may both be neighbour cells of the cell but may not necessarily be neighbours of each other. Thus, whereas a handover may be possible from the cell to the second cell (and may be possible from the cell to the first cell), it may not be possible to handover directly from the second cell to the first cell.

According to an optional feature of the invention, the interference determining means comprises means for determining the neighbour cell interference relationship for the first neighbour cell and the second neighbour cell in response to measurement reports received only from remote stations in an overlap region between the cell and the second cell.

This may allow improved and/or facilitated frequency planning. In particular, the feature may allow a neighbour cell interference relationship to be determined specifically for an area wherein the impact of co-channel frequency allocations to the cells will be most significant. In particular, the frequency plan may be generated taking into account the impact on handover performance from the cell to the second cell if the same frequency is allocated to the first second cells.

The overlap region may be a handover region for handovers from the cell to the second cell.

According to an aspect of the invention there is provided a method of frequency planning for a cellular communication system, the method comprising: receiving measurement reports from a plurality of remote stations; for each of a plurality of cells, determining a neighbour cell interference relationship between at least a first neighbour cell and a second neighbour cell of the cell in response to measurement reports from remote stations served by the cell, the neighbour cell interference relationship being indicative of an interference from the first neighbour cell to the second neighbour cell; and determining a frequency plan in response to the neighbour cell interference relationships.

These and other aspects, features and advantages of the invention will be apparent from and elucidated with reference to the embodiment(s) described hereinafter.

### BRIEF DESCRIPTION OF THE DRAWINGS

Embodiments of the invention will be described, by way of example only, with reference to the drawings, in which

FIG. 1 illustrates an example of a cellular communication system in accordance with some embodiments of the invention;

FIG. 2 illustrates an example of a frequency plan server in accordance with some embodiments of the invention;

FIG. 3 illustrates an example of a cell configuration in a cellular communication system; and

FIG. 4 illustrates an example of a flowchart of a method of frequency planning in accordance with some embodiments of the invention.

### DETAILED DESCRIPTION OF SOME EMBODIMENTS OF THE INVENTION

The following description focuses on embodiments of the invention applicable to a GSM cellular communication system. However, it will be appreciated that the invention is not limited to this application but may be applied to many other cellular communication systems.

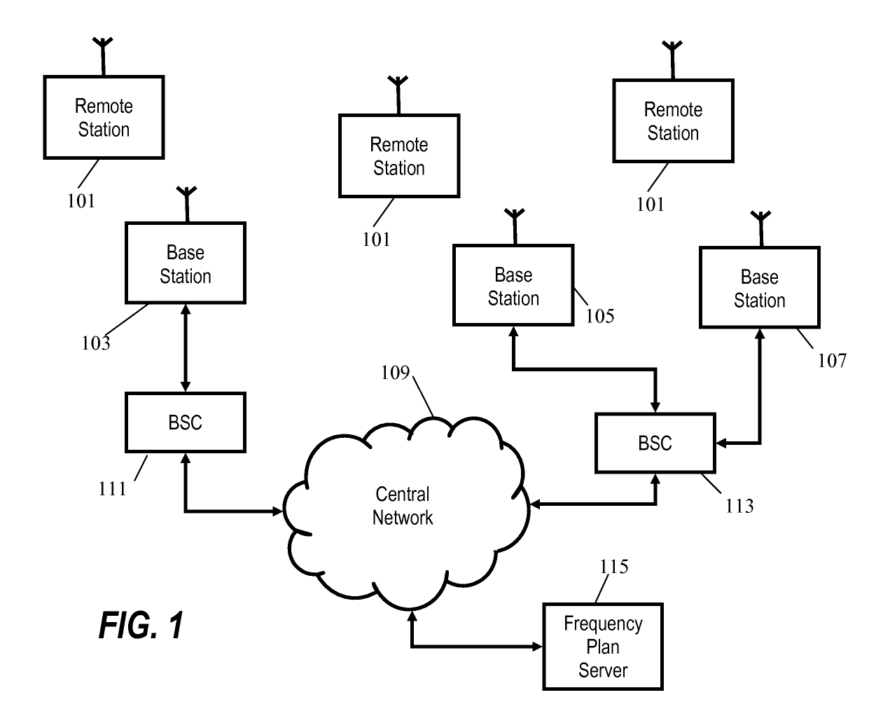

FIG. 1 illustrates an example of a cellular communication system in accordance with some embodiments of the invention.

The cellular communication system is a GSM cellular communication system which supports a plurality of remote stations. In the example three remote station 101 and three base stations 103, 105, 107 are shown but it will be appreciated that a typical cellular communication system will support a large number of remote stations and base stations. A remote station may be any communication entity capable of communicating with a base station (or access point) over the air interface including e.g. a mobile station, a user equipment, a mobile phone, a mobile terminal, a mobile communication unit, a remote station, a subscriber unit, a 3G User Equipment etc.

The base stations 103, 105, 107 are coupled to a GSM central network 109 via Base Station Controllers (BSCs) 111, 113. The central network 109 comprises all aspects of the fixed segment of the GSM communication system including other base stations, BSCs, Mobile Switching Centres etc as will be well known to the person skilled in the art.

The system furthermore comprises a frequency plan server 115 which is capable of generating a new frequency plan at regular intervals. The frequency plan server 115 is arranged to communicate with the base stations 103, 105, 107 and BSCs 111, 113. In particular, the frequency plan server 115 can receive measurement reports received by the base stations 103, 105, 107 from the remote stations 101. Furthermore, when a new frequency plan has been generated the frequency plan server 115 can distribute this to the individual base stations 103, 105, 107 which can then adopt the frequency(ies) assigned to the base stations 103, 105, 107 by the frequency plan.

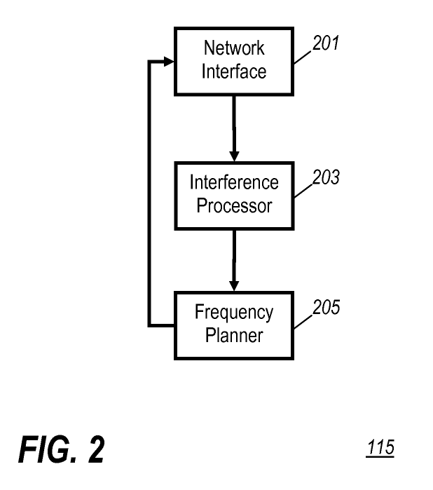

FIG. 2 illustrates an example of the frequency plan server 115 in more detail.

The frequency plan server 115 comprises a network interface which interfaces the frequency plan server 115 to the central network 109. The network interface 201 can communicate data with other elements of the network and can in particular receive measurement reports from the base stations 103-107/BSCs 111,113.

The measurement reports originate at the remote stations 101 which all perform measurements of the pilot signal (specifically the BCCH carrier) transmitted by the individual serving base station 103-107 for the individual remote station 101. Also, the remote stations 101 perform measurements of base stations of neighbour cells which are specified in a neighbour list transmitted to the remote stations 101 from their serving base station 103-107. As will be known to the person skilled in the art, measurement reports are in a GSM system used to determine the most appropriate serving base station 103-107 and in particular is used by the BSCs 111, 113 to make handover decisions. In addition, in the system of FIG. 1, the measurement reports are forwarded (either directly or after some processing of the data of the measurement reports) to the frequency plan server 115 where they are used to determine a new frequency plan.

The network interface 201 is coupled to an interference processor 203 which is arranged to determine interference relationships reflecting the potential interference between different cells. For example, interference relationships may be determined which reflect the estimated interference that will be caused to one cell by another cell if the two cells are allocated the same carrier frequency (e.g. traffic or pilot signal frequency). As another examples, the interference relationship for a cell pair may alternatively or additionally reflect the estimated interference if the cells are allocated adjacent frequencies.

In the specific example, the interference processor 203 calculates neighbour cell interference relationships for a plurality of cells. The neighbour cell interference relationship determined by the interference processor 203 reflects an interference relationship of two neighbour cells which are both neighbours of a given cell but are not themselves neighbours of the given cell. As an example, a remote station served by cell A may handover to cell B or cell C (as these are neighbours of cell A) whereas no handover is possible between cell B and C (as these are not neighbours of each other).

Thus, for each of a plurality of cells, the interference processor 203 determines a neighbour cell interference relationship between at least a first neighbour cell and a second neighbour cell for the cell. The neighbour cell interference relationship is indicative of an estimated interference from the first neighbour cell to the second neighbour cell. The neighbour cell interference relationship is determined from measurement reports that originated at remote stations 101 which are currently served by the cell which has both cells as neighbours. Thus, measurement data for two neighbour cells of a serving cell is compared to determine an estimated relationship between the two neighbour cells.

Thus, in contrast to many conventional frequency planning systems, the system of FIG. 1 allows real life measurement data to be used not only to determine interference relationships between a cell and its neighbours but also between two neighbours which are not themselves neighbours of each other. In other words, an interference relationship can be determined for cells which are not directly adjacent but are divided by a single cell thereby allowing an additional layer of information to be provided.

The interference processor 203 is coupled to a frequency planner 205 which performs frequency planning based on the interference relationships determined by the interference processor 203. As this can include information of interference relationships for cells which are not neighbours of each other, an improved frequency plan and thus performance and capacity of the cellular communication system as a whole can be achieved.

It will be recognized by a skilled person that the frequency plan server 115 may be provided as part of an OMC (Operations and Maintenance Centre) function, or in a separate device, for example a separate device operably coupled to a switching center or may be distributed between different network elements. In particular, it is not necessary for the data collection functionality, the data analysis functionality and the network planning functionality to be located within the same device or network element. As such the frequency plan server 115 may be provided by a separate device of the cellular communication system or by a new OMC in the cellular communication system, or the frequency plan server 115 function may be provided as a software upgrade to an existing OMC or any other network device of the cellular communication system.

Due to the large number of possible frequency plans and the complex interference interrelations between different cells, the frequency planner 205 implements an Automatic Frequency Planning (AFP) tool which takes in a list of interference relationships between cells to produce a frequency plan that minimises interference. The interference relationships quantify the interference in a cell from each potential interfering cell. The AFP then uses this information to produce a frequency plan that minimises the effect of the interference.

Many different algorithms for determining an optimized frequency plan based on an interference matrix are known. Most of these algorithms use advanced search and iterative optimization techniques to find the optimum frequency plan. Such algorithms will be known to the person skilled in the art and will for brevity and clarity not be described further herein.

In the specific example, the AFP is based on the use of an interference matrix which for each cell pair has an entry that indicates the interference relationship between these cells.

The values in the interference matrix are often penalty values, where s higher penalty value indicates a more significant effect of interference from that interferer.

Frequency planning for a GSM cellular communication system typically comprises evaluating the potential interference that may be caused in one cell by transmission in another cell. Specifically, an interference relationship is determined for two cells under the assumption that they are allocated the same carriers. The interference relationship may for example be determined as a carrier to interference ratio or as a penalty value which reflects the impact of allocating the two cells the same frequency (or in some cases adjacent frequencies).

For example a simplified co-channel interference matrix may be given by

| | A | B | C | D | E | F |
|---|---|---|---|---|---|---|
| A | | 1 | 1 | 3 | 1 | 2 |
| B | 1 | | 0 | 0 | 4 | |
| C | 2 | 0 | | 0 | | 2 |
| D | 5 | 1 | 0 | | 1 | 4 |
| E | 1 | 3 | 0 | 0 | | 0 |
| F | 3 | 0 | 4 | 5 | 1 | |

where each entry is indicative of a penalty value that reflects the interference level that will arise if the same carrier is allocated to the corresponding cell of the row and column.

In the example each column represents the transmitting cell and each row represents the receiving cell. For example, if cell B and E are allocated the same carrier frequency, the interference relationship is expected to be such that a penalty value of 4 will be assigned for transmissions from cell E (as received in cell B) and a penalty value of 3 will be assigned for transmissions from cell B (as received in cell E). These penalty values can then be used by a frequency planning algorithm that seeks to reduce the total resulting penalty value.

It will be appreciated that the exemplary interference matrix for clarity is unrealistically small and that a practical interference matrix typically will be much larger and can comprise hundreds of cells with potentially each cell having a large number of interference relationships with other cells.

Conventionally, the interference matrix is determined by determining the individual interference relationships from propagation predictions and/or transmit power assumptions.

In addition (or alternatively) measurements in the field may be obtained from the measurement reports reported from remote stations and may be used to determine the interference relationships. However, as such measurements are made for the neighbour cells of a given serving cell, such an approach is conventionally used only to determine the interference relationship/penalty value for cell pairs that are neighbours of each other.

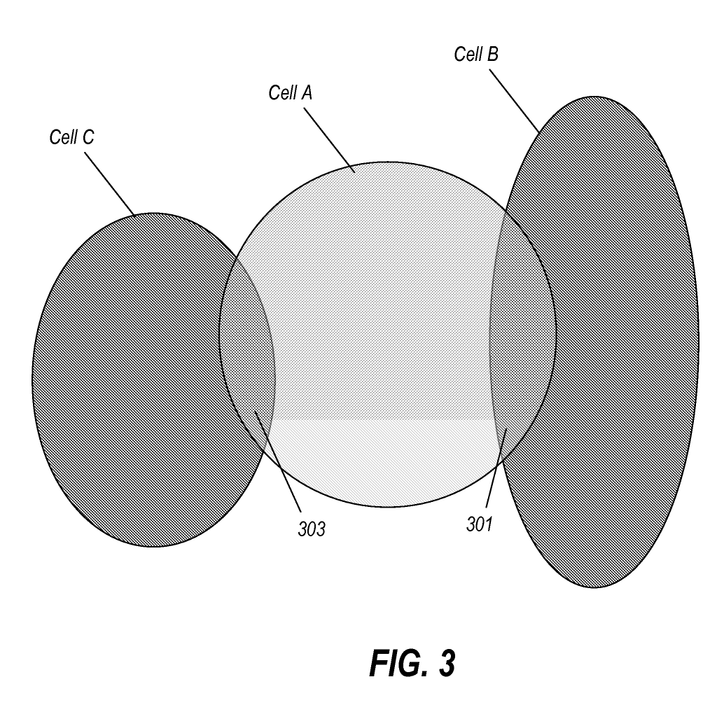

For example, FIG. 3 illustrates an example where cell A has cells B and C as neighbour cells although these are not neighbours of each other. Cell A and B form a first handover region/overlap region 301 wherein both cell A and B may be able to support the remote stations. Thus, within the overlap region 301 remote stations currently served by cell A may handover to cell B. Similarly, cell A and C form a second handover region/overlap region 303 wherein both cell A and C may be able to support the remote stations. Thus, within the overlap region 303, remote stations currently served by cell A may handover to cell C.

However, although no handover region exists between cells B and C, these cells may still cause interference to each other e.g. if they are allocated the same carrier frequencies. In particular, the interference from cell C to cell B may have significant impact on remote stations handing over from cell A to cell B, i.e. to remote stations in the first overlap region 301.

The remote stations served by cell A measure the receive level of the pilot signals from cell A as well as the receive level of pilot signals from the neighbour cells B and C. Conventionally, this information is used to determine an interference relationship between cell A and cell B as well as an interference relationship between cell A and cell C. However, as cells B and C are not neighbours of each other no interference relationship is conventionally determined between cell B and C (Accordingly the entry in the interference matrix for the cell pairs (B,C) and (C,B) are zero (or are determined analytically using propagation models).

However, the inventor of the current invention has realised that measurement reports can be used to determine (or modify) interference relationships for cells that are not neighbours of each other if they share a common neighbour. In the specific example, the measurement reports from cell A are used to determine the interference relationship between cells B and C such that a penalty value can be included (or modified) in the interference matrix for cell pairs (B,C) and (C,B).

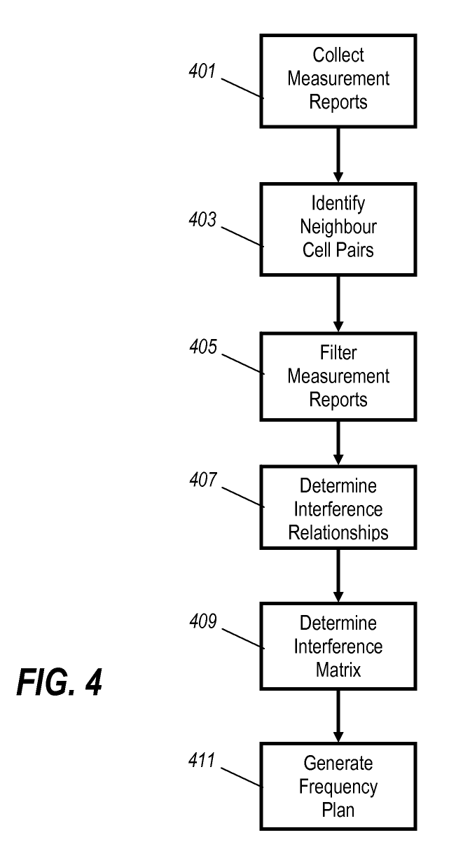

In the following, a more detailed description of the operation of the frequency plan server 115 will be described with reference to FIG. 4 which illustrates a method of frequency planning in accordance with some embodiments of the invention.

The method starts in step 401 wherein measurement reports are calculated for a suitable time interval. For example, all measurement reports received from the cells which are to be frequency planned within the last day, week or month etc may be collected and stored in the frequency plan server 115. As another example, all measurement reports received since the last frequency plan was deployed may be stored.

Step 401 is followed by step 403 wherein neighbour cell pairs are identified for each of the cells included in the frequency plan. Thus, for each cell, the method first determines if any cell pairs exist which contains cells that are both neighbours of the cell but are not neighbours of each other. For example, for cell A, the two cell pairs containing cells B and C are identified.

The method then proceeds in step 405 wherein the measurement reports are filtered such that only a subset of measurement reports are used to determine interference relationships for the neighbour cell pairs.

For example, for the neighbour cell pair (B,C) reflecting the potential interference from cell C to cell B in case the cells are allocated the same frequency, the interference relationship is determined based on the measurement reports from remote stations 101 served by cell A and which are within the overlap region 301 between cell A and B. Thus, for cell A, a neighbour cell interference relationship is determined for cell pair (B,C) based on measurement reports received only from remote stations in the overlap region 301 between cell A and cell B.

It will be appreciated that any suitable way of selecting measurement reports or determining that a remote station 101 is considered to be in the overlap region 301 may be used. In the specific example, a measurement report is considered to be from a remote station 101 in the overlap region 301 if measurement data of the measurement report meets an overlap criterion. The overlap criterion may specifically be that a receive signal quality measure (such as a measured receive level) of a pilot signal from a base station 107 of cell B exceeds a threshold. The threshold may specifically be dependent on a receive signal quality measure (such as a measured receive level) of a pilot signal from a base station 105 serving cell A such that a relative measure can be used to determine if the remote station 101 is in the overlap region 301.

Furthermore, the overlap criterion can also comprise a requirement that the receive signal quality measure for cell B exceeds receive signal quality measure for pilot signals from all other neighbour base stations 103 of cell A. Thus, the overlap region 301 may be considered to correspond only to the region in which cell B would be selected as the handover candidate thereby ensuring that the interference relationship closely reflects the impact on handovers to cell B as this impact is likely to be the most significant effect of interference between cells C and B.

Thus, in the system, the neighbour cell interference relationships and thus the penalty values for the cell pairs are specific to the handover areas between the cells. Accordingly, the effect of the new frequency plan on handover performance can be taken into consideration and in particular the approach can prevent the new frequency plan from negatively (or unacceptably) impacting handover performance.

As a specific example, a measurement report for a GSM system typically contains the server cell (sector) signal strength and the measured signal strength for a number of neighbour cells (sectors). In GSM up to six neighbour measurements can be made (with enhanced measurement report number increases).

In the approach which is targeted at identifying interference sources in the handover regions between cells, only a subset of measurement reports are considered. A measurement report is specifically deemed to have been received in a handover area if the difference between the server signal and a neighbour cell is lower than a threshold.

For example, a measurement report may comprise the following data:

| | Rx |
|---|---|
| Cell | Level |
| A (serving cell) | R_{A} |
| B (neighbour cell) | R_{B} |
| C (neighbour cell) | R_{C} |
| D (neighbour cell) | R_{D} |
| E (neighbour cell) | R_{E} |

The measurement report is considered to be from a remote station 101 in the overlap region 301 if

R_{B}−R_{A}<=HOthresh

where HOthresh is a threshold which can be set for the specific preferences of the individual embodiment. In practice HOthresh may for example be set around zero corresponding to a situation where the signal strengths are equal.

Step 405 is followed by step 407 wherein a neighbour cell interference relationship is determined for each cell pair identified in step 403 and using the filtered measurement reports from step 405. For example, for cell A, a neighbour cell interference relationship may be determined for cell pair (B,C) (as well as potentially for cell pair (C,B) and other cell pairs involving one or more other neighbour cells of cell A).

The neighbour cell interference relationship can specifically be determined in response to the difference between the receive signal quality measure (such as the receive level, RxLev) for the two cells of the cell pair. E.g. the interference relationship for cell pair (B,C) is determined in response to the differences between RxLev measurements for cells B and C received from remote stations 101 in the overlap region 301. As a simple example, a neighbour cell interference relationship for cell pair (B,C) can be determined by subtracting the measured receive level for cell C from the measured receive level for cell B in all measurement reports from the overlap region 301 and then averaging the results (it will be appreciated that appropriate scaling etc may be performed).

Alternatively or additionally, the neighbour cell interference relationship can be determined in response to a proportion of measurement reports that meet a criterion. The criterion can be designed such that it reflects a situation where unacceptable interference is experienced. The interference relationship can then be determined to reflect how large a proportion of the measurement reports received from the overlap region 301 reports that such interference would be experienced.

In the following, a specific example for cell pair (B,C) is given wherein these approaches are combined such that unacceptable interference is considered to be present for measurement reports if the measured receive levels meet a criterion. The neighbour cell interference level is then determined from the proportion of measurement reports from the overlap region 301 for which this is experienced.

First, a difference in measured receive levels R_{B}−R_{C} is determined for each measurement report from the overlap area 301 and compared to an interference margin required for the system. If R_{B}−R_{C}<Interference Margin, cell C is tagged as a potential interferer to cell B for this measurement report.

Based on the comparisons, a neighbour cell interference relationship is determined between cells B and C reflecting a penalty caused to the handover performance in the overlap region 301 if cells B and C are allocated the same frequency. The interference relationship is specifically calculated as the ratio of measurements indicating interference to the total number of measurements collected in the overlap region 301. For example, if one hundred measurement reports have been collected in the overlap region 301 and forty of them indicate that R_{B}−R_{C}<Interference Margin, then the ratio is 40/100=0.4.

In some embodiments, the generated neighbour cell interference relationship can furthermore be adjusted to reflect a significance of the overlap region e.g. relative to other overlap regions and/or other cells. For example, the neighbour cell interference relationship may be adjusted to reflect an amount of measurement reports that have been received from the overlap region 301 and/or an amount of handovers that have taken place in the overlap region 301. Thus, in the specific example, the interference relationship for cell pair (B,C) can be modified in response to the number of measurement reports received from region 301 and/or in response to the number of handovers from cell A to cell B. Thus, the neighbour cell interference relationships can be modified to reflect the impact of the interference to the system as a whole. Specifically, the approach can allow handover areas with high activity to be prioritised higher than handover areas with low activity.

It will be appreciated that although the above description focuses on cell pair (B,C) reflecting interference to cell B from cell C, similar approaches may be used for cell pair (C,B) reflecting interference to cell C from cell B. Such an approach may also be used for other neighbour cell pairs of cell A or for neighbour cell pairs for other cells. In the specific example, the described approach is used for all identified neighbour cell pairs within the plurality of cells which are included in the frequency planning operation.

Thus, the output of cell 407 is a potentially large number of neighbour cell interference relationships which reflect the interference relationships between cells that are not neighbours of each other but are both neighbours of a common intermediate cell.

Step 407 is followed by step 409 wherein these neighbour cell interference relationships are combined into an interference matrix that can be used for frequency planning.

The interference matrix may initially be generated as for a conventional system in that it may include interference relationships for cells and their direct neighbours determined using conventional approaches as will be known to the person skilled in the art. For example, interference relationships for cell pairs (A,B), (B,A), (A,C) and (C,A) may be determined in response to neighbour cell measurements performed in each cell in accordance with conventional approaches.

However, rather than having zero penalty values for cells which are not neighbours (or basing these only on propagation models and calculations or dedicated trial propagation measurements), step 409 includes determining penalty values for cell pairs which are both neighbours of the same intermediate cell but are not themselves neighbours. Thus, for a given such cell pair, a penalty value is included in the interference matrix based on the neighbour cell interference relationship(s) determined for this cell pair in step 407.

For example, for cell pair (B,C) a neighbour cell interference relationship is determined from measurements in cell A. In addition, neighbour cell interference relationships for cell pair (B,C) may have been determined based on other intermediate cells which also have both cell B and C as neighbour cells. Thus, for a given cell pair, one or more neighbour cell interference relationships may have been determined in step 407 and in step 409 these are combined into a single penalty value which is entered into the interference matrix (at the location corresponding to cell pair (B,C)).

As a simple example, a single neighbour cell interference relationship may be determined for cell pair (B,C) and this may directly be entered as the matrix coefficient of the interference matrix reflecting the penalty value for this cell pair (B,C) being allocated the same frequency.

In the situation where a plurality of neighbour cell interference relationships have been generated for a cell pair in step 407 (e.g. the cell pair (B,C)) reflecting that more than one intermediate cell exists which has both cells of the cell pair as neighbours and from which a remote station can handover to the target cell (e.g. cell B in the specific example), these relationships can be combined to generate the matrix coefficient value.

For example, the matrix coefficient penalty value may in a low complexity embodiment be generated by a summation of the neighbour cell interference relationships determined for each of the intermediate cells. It will be appreciated that prior to a combination of the individually determined neighbour cell interference relationships, these relationships may be modified or processed in various ways to generate the desired penalty indication.

It will also be appreciated that the matrix coefficient penalty value for a cell pair may include penalty values determined in other ways. For example, a propagation model based penalty value may be combined with a neighbour cell interference relationship penalty value to generate a single matrix coefficient value.

Step 409 may specifically generate a matrix coefficient reflecting an interference relationship from cell C to cell B in response to a neighbour cell interference indication which is determined substantially as:

$${I}_{X , Y} = {\sum }_{n} F ( R ( {X}_{n} , {Y}_{n} ) )$$

wherein X can represent the cell B, Y can represent the cell C, R(Xₙ,Yₙ) is the neighbour cell interference relationship for the cell pair (B,C) determined for cell n, F is an arbitrary function and the summation n is over all cells having cell B and C as neighbour cells and from which a remote station can handover to the cell B. The summation specifically includes cell A.

Step 409 is then followed by step 411 wherein a frequency plan is generated based on the interference matrix generated in step 409. It will be appreciated that any suitable method or algorithm for determining a frequency plan on the basis of an interference or penalty matrix can be used and that the person skilled in the art will be aware of a number of such algorithms which accordingly will not be described in further detail herein.

It will be appreciated that the above description for clarity has described embodiments of the invention with reference to different functional units and processors. However, it will be apparent that any suitable distribution of functionality between different functional units or processors may be used without detracting from the invention. For example, functionality illustrated to be performed by separate processors or controllers may be performed by the same processor or controllers. Hence, references to specific functional units are only to be seen as references to suitable means for providing the described functionality rather than indicative of a strict logical or physical structure or organization.

The invention can be implemented in any suitable form including hardware, software, firmware or any combination of these. The invention may optionally be implemented at least partly as computer software running on one or more data processors and/or digital signal processors. The elements and components of an embodiment of the invention may be physically, functionally and logically implemented in any suitable way. Indeed the functionality may be implemented in a single unit, in a plurality of units or as part of other functional units. As such, the invention may be implemented in a single unit or may be physically and functionally distributed between different units and processors.

Although the present invention has been described in connection with some embodiments, it is not intended to be limited to the specific form set forth herein. Rather, the scope of the present invention is limited only by the accompanying claims. Additionally, although a feature may appear to be described in connection with particular embodiments, one skilled in the art would recognize that various features of the described embodiments may be combined in accordance with the invention. In the claims, the term comprising does not exclude the presence of other elements or steps.

Furthermore, although individually listed, a plurality of means, elements or method steps may be implemented by e.g. a single unit or processor. Additionally, although individual features may be included in different claims, these may possibly be advantageously combined, and the inclusion in different claims does not imply that a combination of features is not feasible and/or advantageous. Also the inclusion of a feature in one category of claims does not imply a limitation to this category but rather indicates that the feature is equally applicable to other claim categories as appropriate. Furthermore, the order of features in the claims does not imply any specific order in which the features must be worked and in particular the order of individual steps in a method claim does not imply that the steps must be performed in this order. Rather, the steps may be performed in any suitable order.

1. An apparatus for frequency planning for a cellular communication system, the apparatus comprising:
means for receiving measurement reports from a plurality of remote stations;
interference determining means for, for each of a plurality of cells, determining a neighbour cell interference relationship between at least a first neighbour cell and a second neighbour cell of the cell in response to measurement reports from remote stations served by the cell, the neighbour cell interference relationship being indicative of an interference from the first neighbour cell to the second neighbour cell; and
means for determining a frequency plan in response to the neighbour cell interference relationships.

2. The apparatus of claim 1 wherein the interference determining means comprises means for determining the neighbour cell interference relationship for the first neighbour cell and the second neighbour cell in response to measurement reports received only from remote stations in an overlap region between the cell and the second cell.

3. The apparatus of claim 2 wherein the interference determining means comprises means for determining that a measurement report is from a remote station in the overlap region if measurement data of the measurement report meets an overlap criterion.

4. The apparatus of claim 3 wherein the overlap criterion comprises a requirement that a receive signal quality measure of a pilot signal from a base station serving the second cell exceeds a threshold.

5. The apparatus of claim 4 wherein the threshold is dependent on a receive signal quality measure of a pilot signal from a base station serving the cell.

6. The apparatus of claim 3 wherein the overlap criterion comprises a requirement that a receive signal quality measure of a pilot signal from a base station serving the second cell exceeds receive signal quality measures of pilot signals from base stations serving other neighbour cells of the cell.

7. The apparatus of claim 2 wherein the interference determining means is arranged to scale the neighbour cell interference relationship for the first neighbour cell and the second neighbour cell in response to an amount of measurement reports received from the overlap region.

8. The apparatus of claim 1 wherein the neighbour cell interference relationship for the first neighbour cell and the second neighbour cell is determined in response to a difference between a receive signal quality measure of a pilot signal from a base station serving the second cell and a receive signal quality measure of a pilot signal from a base station serving the first cell.

9. The apparatus of claim 1 wherein the interference determining means is arranged to determine the neighbour cell interference relationship for the first neighbour cell and the second neighbour cell in response to a proportion of measurement reports that meet a criterion.

10. The apparatus of claim 1 wherein the interference determining means is arranged to scale the neighbour cell interference relationship for the first neighbour cell and the second neighbour cell in response to an amount of handovers from the cell to the second cell.

11. The apparatus of claim 1 further comprising:
matrix means for generating an interference matrix in response to the neighbour cell interference relationships, each matrix coefficient of the interference matrix reflecting an interference relationship between a cell pair associated with the matrix coefficient; and
wherein the frequency planning means is arranged to determine the frequency plan in response to the interference matrix.

12. The apparatus of claim 11 wherein the matrix means is arranged to generate a matrix coefficient for a cell pair comprising cells not being neighbour cells of each other in response to neighbour cell interference relationships for the cell pair determined for a plurality of cells having both cells of the cell pair as neighbour cells.

13. The apparatus of claim 11 wherein the matrix means is arranged to generate a matrix coefficient reflecting an interference relationship from the first cell to the second cell in response to neighbour cell interference relationships for the first and the second cell determined for plurality of cells from which remote stations may handover to the second cell.

14. The apparatus of claim 11 wherein the matrix means is arranged to generate a matrix coefficient reflecting an interference relationship from the first cell to the second cell in response to a neighbour cell interference indication determined substantially as:
$${I}_{X , Y} = {\sum }_{n} F ( R ( {X}_{n} , {Y}_{n} ) )$$
wherein X represents the first cell, Y represents the second cell, R(Xₙ,Yₙ) is the neighbour cell interference relationship for the first cell and the second cell determined for cell n, F is an arbitrary function and the summation n is over all cells having the first cell and the second cell as neighbour cells and from which a remote station can handover to the second cell.

15. The apparatus of claim 1 wherein the cellular communication system is a Global System for Mobile communication, GSM.

16. A method of frequency planning for a cellular communication system, the method comprising:
receiving measurement reports from a plurality of remote stations;
for each of a plurality of cells, determining a neighbour cell interference relationship between at least a first neighbour cell and a second neighbour cell of the cell in response to measurement reports from remote stations served by the cell, the neighbour cell interference relationship being indicative of an interference from the first neighbour cell to the second neighbour cell; and
determining a frequency plan in response to the neighbour cell interference relationships.
